(19) United States
(12) Patent Application Publication
(10) Pub. No.: US 2004/0130968 A1
(43) Pub. Date: Jul. 8, 2004

(54) Method for improving particle compositions

(75) Inventors: Poul Bach, Birkerod (DK); Henrik Kirk Vilsboll, Copenhagen S (DK); Christian Sommer, Gilleleje (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 10/682,094

(22) Filed: Oct. 9, 2003

Related U.S. Application Data
(60) Provisional application No. 60/417,577, filed on Oct. 10, 2002.

(30) Foreign Application Priority Data
Oct. 9, 2002 (DK) PA 2002 01517

(51) Int. Cl. B01F 13/00

(52) U.S. Cl. 366/348

(57) ABSTRACT

The present invention relates to a method for preparing a particulate composition having improved average strength of particles comprising contacting a particulate starting material with a liquid and subjecting the mixture to high shear at a rate substantially avoiding agglomeration of particles.

### CROSS-REFERENCE TO RELATED APPLICATIONS

This application claims priority or the benefit under 35 U.S.C. 119 of Danish application no. PA 2002 01517 filed Oct. 9, 2002 and U.S. provisional application No. 60/417,577 filed Oct. 10, 2002, the contents of which are fully incorporated herein by reference.

### FIELD OF THE INVENTION

The present invention relates to a method for improving the properties of a particulate starting material or composition by high shear treatment. The method comprises subjecting a particulate starting material and a liquid to high shear treatment optionally followed by separating a desired fraction of particles, wherein the treated particles in particular the desired fraction of particles obtained by separation is smoother and has a higher average particle strength compared to the particulate starting material, in particular the same fraction obtained from the starting particulate material.

### BACKGROUND OF THE INVENTION

It is known from the art to make smooth round particles e.g. enzyme granules in a marumerizer as disclosed in WO 01/23513. It is further known from WO 01/83727 to prepare smooth enzyme particles by fluid bed spray drying processes. It is further known to prepare inert particles such as non-pareil seeds, as disclosed in WO 93/07263, which describes the preparation of non-pareil seeds.

When handling dry solid particles or granules, e.g. during manufacturing, packaging and transportation, a problem may occur when the particles are exposed to shear or impact, as the particles may generate dust due to abrasion, which especially is a problem if the surface roughness of the particles is high. If furthermore the particles are weak they will also be susceptible to breaking due to the forces imposed upon them thus resulting in further formation of dust. As dust may be harmful to man it is desirable to obtain particles with high particle strength which exhibits resistance to breakage and/or to obtain particles which have smooth surfaces to avoid dust formation when they get exposed to shear and impact.

### SUMMARY OF THE INVENTION

We have surprisingly found a process for improving a particulate starting material by high shear treatment, specifically the average particle strength of the particulate starting material is improved and which furthermore makes the particles smooth in a cost effective way.

The present invention is useful whenever it is desired to improve particle strength and/or smoothness of a composition of particles. The high shear treatment destroys the weakest particles of the particulate starting material to be improved are. Particles for which this invention is of interest may be particles comprising active compounds in particular enzyme containing granules. We have further discovered that said process is useful to produce tough smooth inert partide fractions to be used as carrier materials, cores or seeds in a number of applications, within pharmaceutical industry, baking industry, candy industry, food industry, feed industry, fertilizer industry etc. Inert particles used as carrier materials, cores or seeds are known e.g. from the so called non-pareil seeds, which are characterised by spherical particles that have been prepared by agglomeration. The inert particles of the present invention differ from ordinary non-pareil seeds by not being agglomerated into particles but comprise a dense homogenous matrix optionally covered with a layer of binder-matrix. Furthermore, this preparation method is a much more cost effective production method compared to the production method of non-pareil seeds. Furthermore the particles are readily dispersible or soluble in water, preferably fully soluble in water.

We have found that by high shear treatment of a particulate starting material, we are able to obtain a fraction of smooth particles which have higher average particle strength compared to the same fraction before the high shear treatment. During the high shear treatment the weak particles are destroyed and any sharp edges and corners on the particles are worn off. This treatment imitates what the particles may be exposed to during handling after production, which means that any dust that would have been released during handling is now released during the process of the present invention, resulting in fractions of particles with much lower dust figures taken as an average of the fraction compared to the same fraction before the treatment.

Hence one object of the present invention is to provide a method for preparing and/or selecting particles which have improved particle strength and/or satisfactory surface smoothness and/or which release low amounts of dust during handling.

We have surprisingly found that high shear treatment of particles is an efficient way of improving the average strength in a selected fraction of particles by destroying and removing the weakest particles. Thus the average particle strength of particles in a particulate starting material is improved by subjecting the particles to high shear treatment whereby the weakest particles are destroyed and may be removed leaving only the stronger particles.

We have further found that the high shear treatment of particles should be conducted on the particles in the presence of a liquid.

We have further found that to obtain the desired result it is important to adjust the high shear rate to the particle size of the particulate material provided and to the amount of liquid added to the process, to avoid agglomeration of the particles. In other words keeping agglomeration low or even completely avoiding it is important in the process of the invention and the amount of agglomeration can controlled by adjusting the shear rate and/or the amount of liquid added to the process to match the size of the particles being treated.

Hence in a first aspect the present invention provides a method for preparing particulate composition having improved average strength of particles comprising contacting a particulate starting material with a liquid and subjecting the mixture to high shear at a rate substantially avoiding agglomeration of particles.

In a second aspect the invention provides a particulate composition obtainable by the method of the invention.

### BRIEF DESCRIPTION OF DRAWINGS

No figures.

### DETAILED DESCRIPTION OF THE INVENTION

Introduction

When handling solid particles one of the major problems is the formation of dust, which may be harmful to persons handling the dry solid particles. It is known that conventional particles are usually sensible to shear and impact which makes them susceptible to damage when a strain is applied to them, which might happen during handling such as manufacture, packaging and transportation. It is presently contemplated that dust is released when the integrity of solid particles is damaged, e.g. when a solid particle breaks or cracks. This may happen when the solid particle is subjected to strain such as impact or shear e.g. during handling. The strain will cause a corresponding stress building up in the solid particle to counteract the strain. Upon increasing the strain the build up of stress in the particle to counteract the strain may continue to a certain point (the yield point) depending on the particle material. However, if the strain is greater than the forces upholding the integrity of the solid particle (the yield point) the solid particle is no longer able of counteracting the strain, and the strain will cause damage to the physical integrity of the solid particle, which may release dust from the solid particle. This may happen when the particle is exposed to shear or impact, especially particles with high surface roughness cause friction and the edges and corners on the surface of the particle will act as weak areas which are susceptible to breaking off as fragments of the particle or to induce breakage of the entire particle.

Particles for which this is of particularly high relevance are granules containing active compounds such as enzyme granules or granules comprising pharmaceutical agents or granules known from the fertilizer industry and feed industry, where the formation of dust is an issue of great importance. Other particles for which it is important not to form dust and to have smooth surfaces are inert particles which are being used as seeds in further granulation processes, it is important the particles are able of withstanding the strain exposed to them during further processing to avoid breakage and as a result formation of dust. Another issue is to increase the amount of useful seeds which end up as finished granules, which is done by removing weak particles, which are likely to break during further processing. Furthermore it is of importance that the particles are smooth, as sharp edges and corners may act as weak areas, which are especially exposed to rupture or abrasion in which dust is formed. Furthermore, if particles with high surface roughness are coated, the coating has to be of a certain thickness to avoid edges and corners of the particle from sticking out of the coating. If the coating is too thin corners will stick out of the coating and act as weak areas on the finished granule which are susceptible to breaking off or even induce breakage of the entire granule and by that generate dust. Therefore as a first object it is desirable to provide a process for preparing particles with high particle strength and/or smoothness.

During further processing of inert particles such as seeds for enzyme granulation e.g. in coating/granulation processes such as in fluid bed processes, it is easier to control the process if the particles are not too small and therefore too light. However, large particle sizes of the particulate material may cause problems, especially if the method is used to produce seeds which have to be below a certain size, so that the end product does not become too large. It may therefore be desirable to work with particulate materials with high densities to be able to keep the small particle sizes.

A problem may occur if the particles to be treated with high shear start to coalesce by agglomerating during the high shear treatment. It is desirable to avoid the agglomeration of the particles. One way of avoiding coalescence is to control the particle sizes, the density of the particles, the amount of liquid added and the high shear rate, see the section “Coalescing theory”.

For many particles it is desirable that the particles are readily dispersible or soluble in water and often it is desired to have fully soluble particles, e.g. enzymes particles and inert particles used as carrier materials or seeds which are often used in products where it is desirable that the product is readily dispersible or soluble in water and often fully soluble. Therefore it may be important that the materials used to produce said particles are readily dispersible or soluble in water and preferably fully soluble in water. We have found that the present invention is a very cost effective way of preparing water soluble inert particles with higher particle strength than compared to ordinary non-pareil seeds.

Definitions:

Granules/Particles:

The terms “particle” and “granulate” or “granule” are intended to be understood as the same as predominantly spherical or near spherical structures of a macromolecular size.

High Shear:

The term high shear is defined as:

Vᵣ=Vᵢₘₚ/V

Where Vᵣ is the relative swept volume ratio, Vᵢₘₚ is the swept volume which is the swept area multiplied with the speed, and V is the volume of the apparatus chamber where the high shear process is taking place. See “Relative Swept Volume ratio”: ref. Ennis and Lister “The Science & Engineering of Granulation Processes”, 1996.

When Vᵣ is between 0.5 and 3.0 s⁻¹ it is a high shear process.

Particulate Starting Material:

By the term “particulate starting material” is meant the particles chosen to be exposed to the method of the present invention.

Coalescing Theory:

Ennis et al. [B. J. Ennis and J. D. Litster, Size reduction and size enlargement, R. H. Perry and D. W. Green (Eds.), Perry's Chemical Handbook, McGraw-Hill, New York, USA, 1997] has derived a criterion for granule coalescence by stating that the relative kinetic energy of two colliding granules should be completely dissipated by the liquid layer at their surfaces. They calculated how the relative velocity of the granules changed from the moment their liquid layers came into contact during their approach, until the granules rebounded after they collided. When that velocity was reduced to zero, two granules had coalesced. Ennis et al. defined a Stokes numbers for their criterion: the viscous Stokes number,

$${St}_{v} = \frac{8 ρ {υ}_{0} a}{9 μ}$$

Here Stᵥ is the viscous Stokes number, ρ the density of the granules, v₀ the initial velocity, a the granule radius and μ the viscosity of the liquid layer; and the critical viscous Stokes number:

$${St}_{v}^{*} = ( 1 + \frac{1}{e} ) ln ( \frac{h}{{h}_{a}} )$$

Here Stᵥ* is the critical viscous Stokes number, e the coefficient of restitution, h the thickness of the surface liquid layer and ha is a characteristic length of the surface asperities. Ennis et al. then proceeded to state that for a successful collision between two granules to occur, the viscous Stokes number had to be less than or equal to the critical viscous Stokes number. Ennis et al derived expressions to estimate v₀ in fluid beds and rotating drums. They then proposed three regimes of granulation: the non inertial regime, the inertial regime and the coating regime. In the non inertial regime all values of Stᵥ are lower than Stᵥ*. All collisions between granules therefore lead to coalescence. As granules size increases, so does Stᵥ and at some point the maximum value of Stᵥ is approximately equal to Stᵥ*. In the inertial regime the granule kinetic energy and binder viscosity will dictate whether a collision will be successful or not. As granules grow even larger there will be a point where the average value of Stᵥ is equal to Stᵥ*. In this regime the coating regime, most collisions will be unsuccessful.

This means that by producing large particles it is possible to avoid the particles coalescing when granulated, but working with large particles is not wishful when thinking of particles to be used as seeds as the finished granules then will become too large. Another possibility is to increase the density of the seeds or the velocity or decrease the viscosity which will then increase the value of Stᵥ and by that avoiding coalescing when coating the seeds of the present invention in further processing.

Substantially Avoiding Agglomeration of Particles

The term “substantially avoiding agglomeration of particles” as used herein means that no major portions of particles of a particulate composition agglomerates. The person skilled in the art knows that for most particulate materials minor portions of individual particles may adhere to or agglomerate to each other, while, however, this particulate material may not be characterized as agglomerated. The skilled person would readily comprehend the meaning of the term “substantially avoiding agglomeration of particles as meaning that although in principle all particles is kept as single unagglomerated particles, insignificant levels of agglomeration of particles may still occur, without affecting the overall properties of the composition. In particular “substantially avoiding agglomeration of particles” means that more than 80%, in particular more than 85%, in particular more than 90%, in particular more than 95%, most particular more than 98% of the un-agglomerated particles in the particulate starting material is kept in the unagglomerated form.

SPAN Value:

The SPAN value is a measure of the breadth the particle size distribution (PSD) and is defined as:

(D90-D10)/D50

wherein the D values express the mass mean diameter of the individual particles. The mean mass diameter, D50, is the diameter at which 50% of the enzyme particles, by mass, have a smaller diameter, while 50% by mass have a larger diameter. The values D10 and D90 are the diameters at which 10% and 90%, respectively, of the particles, by mass, have a smaller diameter than the value in question. The smaller the SPAN value is, the narrower the particle size distribution is.

Fraction:

By the term “fraction” is meant a particular part of the entire amount of particulate material which has a desired particle size, e.g. 300 micrometer to 600 micrometer, which has been separated from the rest e.g. by sieving.

By comparison of the “same fraction” is meant comparison of particles obtained before and after the particulate material has been exposed to the method of the present invention with specific particle sizes e.g. 300 to 600 micrometer.

Dust Particles:

By the term “dust particles”, which may be adhering to the surfaces of the particles after the high shear treatment, is meant fragments of whole particles, which usually have a considerably smaller size than the particles of the particulate material. Dust particles typically have an irregular non-spherical and abrupt structure such as rod or flake shaped. Dust particles are typically much smaller than the average size of the particles of the particulate material, and most dust particles are, depending on the particulate material, less than 20 micrometer in diameter.

Smoothness:

Smoothness can be described by a shape factor which is defined by:

ξ=p²/4πA

where A is the area of the particle and p the perimeter of the particle. This shape factor has a maximum value of 1 for a true spherical particle. It defines roundness and can be used to measure departures from circularity or surface smoothness.

The shape factor is dimensionless since shape does not depend on size. The divisor and dividend must have the same units, e.g. area/length×perimeter or it may be a number, such as the number of corners per grain. The shape factor is also independent of the orientation of the feature. The perimeter p should be used with caution since its value depends on the resolution of the measuring instrument.

Water Soluble:

Water soluble” particulate materials or fractions of materials in the context of the present invention are understood to be particulate materials of fractions of materials of which at least 50 g/l and more particularly, at least 80 g/l dissolve in water at a temperature of 30° C.

Particle Density:

The particle density is defined as the mass of particles divided by the volume of a liquid which is displaced by particles. The liquid is chosen so that it does not dissolve the particles and it is preferably a viscous liquid. The displaced volume is measured using a pkynometer flask. The density of the chosen liquid is measured at the applied temperature as part of the procedure.

Materials:

Particulate Starting Materials:

The particulate starting material of the present invention can be ny composition of particulate material which average particle strength or smoothness or both needs improvement. The particulate materials may be selected from but are not limited to granules comprising active compounds such as pharmaceutical granules, enzyme granules, fertilizer granules, and the particulate material may further be selected from inert particles, such as particles comprising a salt or a carbohydrate or a combination. In a particular embodiment of the present invention the particulate starting material is granules comprising active compounds, in a more particular embodiment of the present invention the active compounds present in the particulate starting material are enzymes. In a particular embodiment the particulate starting material comprises, contains or consist an inorganic or organic carrier compound. This compound is in particular selected from the group of salts and carbohydrates, in a more particular embodiment the particulate starting material is selected from the group of salts and sugars. In a more particular embodiment of the present invention the particulate starting materials are inert particles. In a particular embodiment of the present invention inert particles such as salt or sugar particles are used as particulate starting material. In a more particular embodiment the particulate starting materials are chosen from crystalline material. In a particular embodiment of the present invention the particulate material is water soluble.

In the present invention the particulate starting material particularly has a density of at least 1.1 g/cm³, more particular the particulate material has a density f at least 1.3 g/cm³, more particular the particulate material has a density of at least 1.5 g/cm³, even more particular the particulate material has a density of at least 2.0 g/cm³ and most particular the particulate material has a density of at least 2.5 g/cm³.

In a particular embodiment of the present invention the particulate material is characterised by having a particle size, in particular an average particle size of at least 50 micrometer, more particular of at least 100 micrometer and most particular of at least 200 micrometer. In another particular embodiment of the present invention the particulate material is characterised by having a particle size, especially an average particle size, of less than 800 micrometer such as less than 600 μ [symbol] χρoμετερ. More particularly the particulate material is characterised by having a particle size, especially an average particle size, from 300 micrometer to 600 micrometer.

Enzyme Granules:

The granules comprising enzymes which are relevant as particulate starting materials for the present invention may be any particle comprising enzymes at any stage during the manufacture of enzyme granules, where it is appropriate to use the method of the present invention.

Salt:

The salts suitable as particulate starting materials, and as additional materials, in the present invention may be inorganic salts, e.g. salts of sulfate, sulfite, phosphate, phosphonate, nitrate, chloride or carbonate or salts of simple organic acids (less than 10 carbon atoms e.g. 6 or less carbon atoms) such as citrate, malonate or acetate. Examples of cations in these salt are alkali or earth alkali metal ions, ammonium ion or metal ions of the first transition series, such as sodium, potassium, magnesium, calcium, zinc or aluminium. Examples of anions include chloride, bromide, iodide, sulfate, sulfite, bisulfite, thiosulfate, phosphate, monobasic phosphate, dibasic phosphate, hypophosphite, dihydrogen pyrophosphate, tetraborate, borate, carbonate, bicarbonate, metasilicate, citrate, malate, maleate, malonate, succinate, lactate, formate, acetate, butyrate, propionate, benzoate, tartrate, ascorbate or gluconate. In particular alkali- or earth alkali metal salts of sulfate, sulfite, phosphate, phosphonate, nitrate, chloride or carbonate or salts of simple organic acids such as citrate, malonate or acetate may be used. Specific examples include Na₂HPO₄, Na₃PO₄, (NH₄)H₂PO₄, KH₂PO₄, Na₂SO₄, K₂SO₄, KHSO₄, ZnSO₄, MgSO₄, CuSO₄, Mg(NO₃)₂, (NH₄)₂SO₄, sodium borate, magnesium acetate and sodium citrate.

The soluble salt may also be a hydrated salt, i.e. a crystalline salt hydrate with bound water(s) of crystallization, such as described in WO 99/32595. Examples of hydrated salts include magnesium sulfate heptahydrate (MgSO₄(7H₂O)), zinc sulfate heptahydrate (ZnSO₄(7H₂O)), copper sulfate pentahydrate (CuSO₄(5H₂O)), sodium phosphate dibasic heptahydrate (Na₂HPO₄(7H₂O)), magnesium nitrate hexahydrate (Mg(NO₃)₂(6H₂O)), sodium borate decahydrate, sodium citrate dihydrate and magnesium acetate tetrahydrate.

Carbohydrates:

Suitable carbohydrates of the present invention may be selected from but are not limited to pectin, starch, modified starch, cellulose, modified cellulose, carrageenan, gum Arabic, acacia gum, xanthan gum, locust bean gum, guar gum, sugars such as monosaccharides e.g. glucose an fructrose, disaccharides e.g. sucrose, polysaccharides e.g. Hyaluronic acid and dextrin. As employed in the context of the present invention, the term “modified starch” denotes a starch (native starch), which has undergone some kind of at least partial chemical modification, enzymatic modification, and/or physical or physicochemical modification, and which—in general—exhibits altered properties relative to the “parent” starch.

Relevant chemical modifications include, but are not limited to: esterification of hydroxy groups (achieved, e.g. via acetylation); etherification of hydroxy groups; oxidation (achieved, e.g. via reaction with chlorine or hypochlorite); and cross-linking (achieved, e.g. by reaction with formaldehyde or epichlorohydrin).

Relevant enzymatic modifications include, for example, treatment with a starch-degrading or starch-modifying enzyme, e.g. an amylase, such as an α-amylase or glucoamylase.

Relevant physical or physicochemical modifications include, in particular, so-called gelatinisation. The term “gelatinised”, in the context of starch, is used herein in accordance with usage in the art (see, e.g. A. Xu and P. A. Seib, Cereal Chem. 70 (1993), pp. 463-470).

Starches (naturally occurring starches) from a wide variety of plant sources appear to be suitable in the context of the invention (either as starches per se, or as the starting point for modified starches), and relevant starches include starch from: rice, corn, wheat, potato, oat, cassava, sago-palm, yuca, barley, sweet potato, sorghum, yams, rye, millet, buckwheat, arrowroot, taro, tannia, and may for example be in the form of flour.

Cassava starch is among preferred starches in the context of the invention; in this connection it may be mentioned that cassava and cassava starch are known under various synonyms, including tapioca, manioc, mandioca and manihot.

In a particular embodiment of the present invention the particulate material is a carbohydrate, in a more particular embodiment of the present invention the particulate material is a sugar.

As mentioned above it may be of great importance that the particles are soluble in water. This applies to large number of particles such as enzyme granules, fertilizer granules, detergent granules, inert particles used as seed in production of enzyme granules or pharmaceutical granules etc.

Simultaneously or after loading of the particulate material to the high shear apparatus, a liquid may be added to the high shear process. We have surprisingly found that by adding a liquid to the high shear treatment we are better able of controlling the avoidance of coalescence of the particles, furthermore the liquid helps the process of achieving smooth particles. The amount of liquid and the high shear rate is adjusted to suppress agglomeration. The control is obtained by adjusting the high shear rate and/or the amount of liquid added and/or the viscosity of liquid added.

Liquid:

The liquid can be a liquid or a liquid composition, such as a dispersion, a solution or an emulsion. The liquid can be but is not limited to water and oils particularly vegetable oils. In a particular embodiment the liquid is water. In a particular embodiment the present invention the liquid is an aqueous composition. In a particular embodiment of the present invention the liquid is an emulsion.

Additional materials may be added to the liquid to form a liquid composition. Suitable additional materials may be but are not limited to salts, carbohydrates, binders, fibres, fillers, or other conventional coating materials.

Depending on the process equipment used certain problems may occur when mixing the liquid with the particulate material during high shear treatment. When adding the liquid to the particulate material the particulate material may start to slightly dissolve until the liquid is saturated with the particulate material. This will happen if the mixing of the liquid composition and the particulate material is not fast enough and the dispersion of the particles takes too long time before a saturated blend is obtained. It may result in local areas where the particulate material is exposed to a higher degree of dissolution than elsewhere in the apparatus to get the liquid saturated; this will cause some particles to dissolve more than others resulting in differences in particle size. To avoid this one solution is to prepare a saturated liquid composition of the particulate material before adding the liquid composition to the particulate particles in the high shear process.

In a particular embodiment of the present invention the liquid is a saturated solution of one or more or compounds present in the particulate material.

The additional material added to the liquid of the present invention is found to improve the process either by improving the smoothness of the particulate material or by controlling the dissolving of the particulate material.

The amount of liquid added to the high shear treatment is of great importance. If a too high amount of liquid is added to the particulate material, the composition exposed to the high shear process will become too sticky and the particulate material will start agglomerating. In a particular embodiment of the present invention the amount of liquid added to the high shear treatment is not exceeding 20% by weight, in a more particular embodiment the amount of liquid added to the high shear treatment is not exceeding 15% by weight, in an even more particular embodiment of the present invention the amount of liquid added to the high shear treatment is not exceeding 10% by weight.

Additional Materials:

Components which may be additionally added to the high shear treatment process e.g. to improve the smoothness of the obtained granules are salts, polysaccharides, binders, fibres, fillers including anti-dusting or anti-caking materials such as cellulose fibres or finely divided silicium dioxide or other conventional coating materials. These materials may be added to the liquid or on their own. We have further found that addition of certain components on their own to the high shear treatment process has a positive influence on the smoothness of the obtained granules.

Salts and carbohydrates are mentioned above.

Binders:

Binders include materials with a high melting point or no melting point at all and which are of a non waxy nature e.g. polyvinyl pyrrolidon, dextrins, polyvinylalkohol, cellulose derivatives, for example hydroxypropyl cellulose, methyl cellulose or CMC. A suitable binder is a carbohydrate binder such as Glucidex 21 D available from Roquette Freres, France.

Waxes:

The term wax as used herein is to be understood as a compound having a melting point between 20-150° C. Preferred waxes are organic compounds or salts of organic compounds having a melting point in the said range. In the context of the invention the term wax as used herein also encompasses mixtures of two or more different waxes. Also, an important feature of the wax or mixture of waxes is that the wax should be water soluble or water dispersible, particularly in neutral and alkaline solution, so that when the coated particles of the invention are introduced into an aqueous solution, i.e. by diluting it with water, the wax should disintegrate and/or dissolve providing a quick release and dissolution of the active compound incorporated in the particles to the aqueous solution. Examples of water soluble waxes are poly ethylene glycols (PEG's). Accordingly amongst water soluble waxes the solubility of wax in water should in particular be up to 75 parts wax to 25 parts water.

The wax of the invention may be any wax, which is chemically synthesized. It may also equally well be a wax isolated from a natural source or a derivative thereof. Accordingly, the wax of the invention may be selected from the following non limiting list of waxes:

Poly ethylene glycols, abbreviated PEG, type of wax. Different PEG waxes are commercially available having different molecular sizes.

polypropylens or polyethylens or mixtures thereof.

Nonionic tensides which are solid at room temperature such as ethoxylated fatty alcohols having a high level of ethoxy groups such as Lutensol AT80 from BASF having 80 units of ehtyleneoxide per molecule. Alternatively polymers of ethyleneoxide, propylene-oxide or copolymers thereof are useful, such as in block polymers, e.g. Pluronic PE 6800 from BASF Germany.

Waxes isolated from a natural source, such as Carnauba wax, Candelilla wax and bees wax. Other natural waxes or derivatives thereof are waxes derived from animals or plants, e.g. of marine origin.

Fatty acid alcohols, such as the linear long chain fatty acid alcohol NAFOL 1822 (C18, 20, 22) from Condea Chemie GMBH

Germany, having a true density of about 0.96 g/cm3.

Mono-glycerides and/or di-glycerides, such as glyceryl stearate, wherein stearate is a mixture of stearic and palmitic acid, are useful waxes. An example of this is Dimodan PM—from Danisco Ingredients, Denmark—having a true density of about 1 g/cm3

Fatty acids, such as hydrogenated linear long chained fatty acids.

Paraffines, i.e. solid hydrocarbons.

Micro-crystalline wax.

In further embodiments waxes which are useful in the invention can be found in C. M. McTaggart et. al., Int. J. Pharm. 19, 139 (1984) or Flanders et.al., Drug Dev. Ind. Pharm. 13, 1001 (1987) both incorporated herein by reference.

Polypeptide:

Polypeptide may be selected from gelatin, collagen, casein, chitosan poly aspartic acid and poly glutamatic acid.

Synthetic Polymers:

Synthetic polymers may be selected from polyvinyl pyrrolidone (PVP), polyvinyl alcohol (PVA), polyvinyl acetate, polyacrylate, polymethacrylate, poly-acrylamide, polysulfonate, poly-carboxylate, and copolymers thereof, in particular water soluble polymers or copolymers.

Other materials such as conventional granule materials, in particular materials, which are soluble or dispersible in water, may also be added to the high shear treatment process. Conventional granule materials are described e.g. in WO 89/08694, WO 89/08695, EP 270608 B1 and/or WO 00/01793. Other examples of conventional granule materials may be found in U.S. Pat. No. 4,106,991, EP 170360, EP 304332, EP 304331, EP 458849, EP 458845, WO 97/39116, WO 92/12645A, WO 87/07292, WO 91/06638, WO 92/13030, WO 93/07260, WO 93/07263, WO 96/38527, WO 96/16151, WO 97/23606, U.S. Pat. No. 5,324,649, U.S. Pat. No. 4,689,297, EP 206417, EP 193829, DE 4344215, DE 4322229 A, DD 263790, JP 61162185 A and/or JP 58179492.

Fibres:

Fibre materials can be but are not limited to pure or impure cellulose in fibrous form. This can be sawdust, pure fibrous cellulose, cotton, or other forms of pure or impure fibrous cellulose. Also, filter aids based on fibrous cellulose can be used. Several brands of cellulose in fibrous form are on the market, e.g. CEPO™ and ARBOCELL™. Pertinent examples of fibrous cellulose filter aids are Arbocel BFC200™ and Arbocel BC200™. Also synthetic fibers may be used as described in EP 304331 B1 and typical fibers may be made of polyethylene, polypropylene, polyester, especially nylon, polyvinylformate, poly(meth)acrylic compounds.

In a particular embodiment of the present invention the fraction obtained in (d) is water soluble.

The Process:

As described, supra, the method of the invention is a method for preparing a particulate composition having improved average strength of particles comprising contacting a particulate starting material with a liquid and subjecting the mixture to high shear at a rate substantially avoiding agglomeration of particles.

As described it is contemplated that the high shear treatment destroys weak particles leaving the stronger particles, meaning that the weaker particles break into minor particles which can be separated from the intact stronger particles.

In a particular embodiment the method further includes isolating a fraction of the treated particulate composition so as to remove any remains of broken particles and/or over-sized portions of agglomerated particles from the resulting product. In particular the isolated fraction comprises, contains or consists of unbroken or whole particles from the particulate starting material and have a higher average particle strength that the particles of the particulate starting material.

In a particular embodiment the method of the invention is a method for improving average particle strength of a particulate material comprising:

(a) providing a particulate starting material to be improved

(b) providing a liquid

(c) subjecting the particulate starting material and liquid to high shear treatment wherein the amount of liquid added and the high shear rate is adjusted as to substantially avoid agglomeration of particles and

(d) separating a desired fraction of particles wherein the desired fraction of particles obtained by separation has a higher average particle strength compared to the same fraction obtained from the starting particulate material provided in (a).

In a particular embodiment a fraction of the particulate starting material is chosen or selected for the high shear treatment for example by screening or sieving to obtain the right particle size. Too small particle sizes may result in agglomeration of the particles during high shear treatment which is undesired as agglomerated particles are porous and less tough compared to the product obtained by the present invention. On the other hand it is in some cases important that the particle sizes of the starting materials are not too large, as the end product then will be too large. This is especially relevant when employing the method of the present invention on inert particles which are to be used as seeds in further processing, e.g. for use in manufacturing of enzyme containing granules or pharmaceuticals. Furthermore, it may be desirable to obtain a narrow span value after the high shear treatment and by decreasing the span value before the treatment, the amount of the finished product within the desired span value will, other things being equal, be increased. In a particular embodiment of the present invention the lower sieve being used is a 200 micrometer sieve in a more particular embodiment the lower sieve being used is a 300 micrometer sieve. In a particular embodiment of the present invention the upper sieve being used is an 800 micrometer sieve, in a more particular embodiment the upper sieve being used is a 600 micrometer sieve.

The particulate starting material, fractioned or un-fractioned, is added to the high shear apparatus, simultaneously, before or after adding the liquid to the high shear apparatus.

The particulate materials and liquid are exposed to high shear treatment until a desired low level of weak particles has been reached or a desirable amount of weak particles has been destroyed. In a particular embodiment of the present invention the particulate starting material and liquid is exposed to high shear until at least 5%, in particular at least 10%, more particularly at least 15% of the particles are destroyed or broken down to a size outside the size distribution of the particulate starting material

The high shear treatment may be in a high shear mixer apparatus such as in a Lödige mixer or similar drum type mixers. In a particular embodiment of the present invention the high shear treatment is taking place in a high shear mixer and the high shear is measured to be in the range of 0.5 s⁻¹ and 3 s⁻¹.

During the high shear treatment the particles become smoother. To improve this effect a possibility is to add binders, fillers, anti dusting or anti-caking agents.

After the high shear treatment the particulate material may be dried in an apparatus suitable for drying particles, e.g. a fluid bed apparatus, flash dryer, ring flash dryer or other convective drying apparatuses. During the high shear treatment a high amount of dust may be formed. Some of that dust may still adhere to the surface of the finished particulate material after the high shear step. The removal of such dust particles present on the particles happens during the drying step. In a particular embodiment of the present invention the treatment comprise the step of drying the particulate material, in particular before any steps sifting or screening the product into desired fractions.

It is desirable to obtain a narrow span value of the finished particulate material; one way of obtaining a narrow span value is by sieving or screening the finished particulate material. In a particular embodiment of the present invention the finished particulate materiel is screened with a lower size sieve of 300 micrometer and an upper size sieve of 600 micrometer to obtain a desired fraction, or a lower sieve of 250 micrometer and an upper sieve of 500 micrometer. In a particular embodiment of the present invention the particle size of the fraction obtained during the separation step of the present invention is particularly 200 to 800 micrometer with a mean particle size of 450 micrometer, in a more particular embodiment the particle size of the fraction obtained during the separation step of the present invention is particularly 300 to 600 micrometer.

A desired fraction of particles obtained by separation after the high shear treatment has a higher average particle strength compared to a comparable fraction obtained from the particulate starting material. Furthermore the particles of such desired fraction are smoother than comparable particles of the particulate starting material.

The high shear treatment may be done any number of times until no more improvement can be achieved.

In a particular embodiment of the invention the improvement in particle strength is measured by comparing of the high shear treated product with the particulate starting material, especially comparable fractions thereof, on the ability to withstand stress without breaking.

Product Obtainable From the Process of the Invention

The invention also provides a particulate composition obtainable from the method of the invention. The particle strength of the particles can be tested by a standard Attrition Shear Cell where it is tested how much stress the particles can withstand before breakage. Hence the average particle strength of a particulate composition can be measured and compared to that of another composition. Hence in the amount of particles in a first composition which breaks at a certain stress is smaller than the amount of broken particles of a second composition at the same level of stress, the first composition have a higher average particle strength.

We have found that the industrial relevant normal stress levels the products produced by the present invention have to resists are above 15 to 20 kPa.

In a particular embodiment the particles of the particulate composition have a strength so that at least 95 wt % of the particles are capable of withstanding 20 kPa in an AJAX standard attrition shear cell, more particularly at least 95 wt % of the particles are capable of withstanding 25 kPa in an AJAX standard attrition shear cell.

In an embodiment wherein the particulate composition if the invention is enzyme granules at least 97 wt % of the granules are preferably is capable of withstanding 20 kPa in an AJAX standard attrition shear cell. An attrition shear cell is described by Neil and Bridgwater “Attrition of particulate solids under shear”, Powder Tech-nology, vol 80, pp. 207-219, 1994. In particular

For inert particles exposed to the present invention which are to be used as cores or seeds in further processing, the extent of breakage is in particular below 6 wt % when exposed to normal stresses of 0 to at least 30 kPa in an AJAX standard attrition shear cell, more particular the extent of breakage is in particular below 5 wt % when exposed to normal stresses of 0 to at least 30 kPa in an AJAX standard attrition Cell.

The smoothness of the particles can be described by a shape factor, ξ, see the section “Definitions”.

One way of determining the perimeter p is by use of following equipment and software:

JVC Colour Video Camera TK-1070E

Wild Heerbrugg Microscope

Adobe Photoshop (image analysis software)

A picture of the particles is digitalized using Photoshop, which subsequently calculates A and p.

The particles of the particulate starting material will typically have a shape factor ξ<0.5 while the particles of the composition if the invention will have a shape factor ξ>0.5. In a particular embodiment of the present invention the shape factor, ξ, of the particulate starting material is less than 0.5 before the high shear treatment and the shape factor, ξ, of the particles obtained by the method is greater than 0.5, such as 0.6 or 0.7 after the high shear treatment. In a particular embodiment of the present invention the shape factor of the particulate starting material is improved by at least 0.1, such as least 0.2 for example least 0.3 during the high shear treatment.

### EXAMPLES

### Example 1

A mixture of:

300 g pregelatineret starch Cerestar C*Gel Instant

300 g W-80 dextrin

350 g sorbitol

5000 g water

is prepared. This mixture is added to a batch of 20 kg of Sodium sulphate crystals (size range 300 to 600 micrometer) and 660 g Cellulose BE600/10 using a 50 L Lödige high shear mixer.

The shovels are run at a speed of 60 rpm and the chopper is run at 600 rpm for 1 minute to mix the crystals and the cellulose powder. The dosing is done thereafter in 60 sec. using a total amount of 9.75% by wt of the dry cores added. Processing of the batch continues for 120 sec. after the dosing step using a shovel speed of 100 rpm and a chopper speed of 1000 rpm.

The processed wet product is subsequently dried in a fluid bed using an inlet temperature of 90° C. until the product temperature reaches 60° C.

The dried product is screened using a lower (fines) sieve of 300 micrometers and an upper (coarse) sieve of 600 micrometers.

The physical yield was found to be:

| Coarse fraction | >600 micrometer: 5.5% |
|---|---|
| Fines fraction | <300 micrometer: 7.1% |
| Product fraction: | 87.4% |

In table 1 is given the extent of breakage of three different fractions of particulate material when exposed to increasing levels of stress. The first fraction is the produced particulate material, Na₂SO₄, which has been exposed to the high shear treatment, the second fraction is untreated particulate starting material, “raw salt”, and the third fraction is a commercial available non-pareil core. For all three kinds of particles the comparison was made on sieved fractions with particle sizes of 300 to 600 micrometer. An AJAX standard Attrition Shear Cell was used. The industrial relevant normal stresses the inert particles used as seeds or cores have to resist are above 15-20 kPa. It is seen from table 1 that the fraction of the treated material on an average has improved significantly compared to the untreated “raw salt” and that the particle strength of the treated particles is much higher than the particle strength of the non-pareil cores.

TABLE 1
Extent of breakage of particulate material when exposed to stress.

| | Normal stress, | |
|---|---|---|
| | P, kPa | Extent of breakage % |
| The sodium sulphate particles of | 1.01 | 0.94 |
| example 1, exposed to the high | 3.24 | 1 .83 |
| shear treatment of the present | 6.59 | 2.76 |
| invention | 10.98 | 3.23 |
| | 17.12 | 3.77 |
| | 22.69 | 4.14 |
| | 30.50 | 3.98 |
| Raw salt particles, particulate | 3.24 | 0.18 |
| starting material | 5.47 | 1.10 |
| | 6.59 | 1.56 |
| | 8.19 | 2.30 |
| | 10.42 | 4.16 |
| | 12.10 | 5.42 |
| | 13.77 | 6.55 |
| | 17.12 | 9.08 |
| | 19.35 | 10.17 |
| | 22.69 | 12.31 |
| Non pareils | 3.24 | 0.11 |
| | 5.47 | 0.39 |
| | 6.59 | 0.80 |
| | 8.19 | 2.00 |
| | 10.98 | 3.37 |
| | 13.77 | 5.54 |
| | 19.35 | 9.16 |
| | 22.69 | 10.87 |

### Example 2

A mixture of 900 g Maltose dextrin and 5000 g water is prepared. This mixture is added to a batch of 20 kg of Sodium sulphate crystals in the size range 250 to 500 microns using a 50 L Lödige high shear mixer. The shovels are run at a speed of 80 rpm and the chopper is run at 800 rpm. The dosing is done in 60 sec. using a total amount of 10% by wt of the dry cores added. Processing of the batch continues for 120 sec. after the dosing step using a shovel speed of 100 rpm and a chopper speed of 1000 rpm.

The processed wet product is subsequently dried in a fluid bed using an inlet temperature of 90° C. until the product temperature reaches 60° C.

The dried product is screened using a lower (fines) sieve of 250 microns and an upper (coarse) sieve of 500 microns.

The physical yield was found to be:

| Coarse fraction | >500 micrometer: 14.0% |
|---|---|
| Fines fraction | <250 micrometer: 26.4% |
| Product fraction: | 59.6% |

### Example 3

A mixture of 3000 g Sodium Sulphate and 7000 g water is pre-pared. This mixture is added to a batch of 20 kg of Sodium sulphate crystals in the size range 250 to 500 microns using a 50 L Lödige high shear mixer. The shovels are run at a speed of 80 rpm and the chopper is run at 800 rpm. The dosing is done in 60 sec. using a total amount of 10% by wt of the dry cores added. Processing of the batch continues for 120 sec. after the dosing step using a shovel speed of 100 rpm and a chopper speed of 1000 rpm.

The processed wet product is subsequently dried in a fluid bed using an inlet temperature of 90° C. until the product temperature reaches 60° C.

The dried product is screened using a lower (fines) sieve of 250 microns and an upper (coarse) sieve of 500 microns.

The physical yield was found to be:

| Coarse fraction | >500 micrometer: 18.7% |
|---|---|
| Fines fraction | <250 micrometer: 17.3% |
| Product fraction: | 64% |

1. A method for preparing a particulate composition having improved average strength of particles comprising contacting a particulate starting material with a liquid and subjecting the mixture to high shear at a rate substantially avoiding agglomeration of particles.

2. The method of claim 1 further comprising the step of isolating a fraction of particles comprising, containing or consisting of unbroken or whole particles from the particulate starting material having a higher average particle strength that the particles of the particulate starting material.

3. The method of claim 2 comprising:
(a) providing a particulate starting material to be improved
(b) providing a liquid
(c) subjecting the particulate starting material and liquid to high shear treatment wherein the amount of liquid added and the high shear rate is adjusted as to substantially avoid agglomeration of particles and
(d) separating a desired fraction of particles wherein the desired fraction of particles obtained by separation has a higher average particle strength compared to the same fraction obtained from the starting particulate material provided in (a).

4. The method according to claim 1, wherein the particulate starting material is characterised by having a particle size of at least 50 μm.

5. The method according to claim 1, wherein the particulate starting material is characterised by having a particle size of at least 100 μm.

6. The method according to claim 1, wherein the particulate starting material is characterised by having a particle size of at least 200 μm.

7. The method according to claim 1, wherein the particulate starting material is characterised by having a particle size of less than 800 μm.

8. The method according to any of the claims 1 to 7, wherein said particulate starting material has a density of at least 1.3 g/cm³.

9. The method according to any of the claims 1 to 7, wherein said particulate starting material has a density of at least 1.5 g/cm³.

10. The method according to any of the claims 1 to 9, wherein the particulate starting material is granules comprise an active compound.

11. The method according to claim 10, wherein the active compound is an enzyme.

12. The method according to claim 1, wherein the particulate material is selected from the group of salt and sugar.

13. The method according to any of the claims 1 to 12, wherein the liquid is water or oil.

14. The method according to any of the claims 1 to 12, wherein the liquid is aqueous.

15. The method according to any of the claims 1 to 12, wherein the liquid is a saturated solution of one or more of the compounds present in the particulate material.

16. The method according to claim 13, wherein salt, carbohydrates, binders, fibres, fillers, or other conventional coating materials are added to the liquid.

17. The method according to claim 1, wherein the particulate material is water soluble.

18. The method according to any of claims 1 to 17, wherein the high shear treatment performed in a high shear mixer and the applied shear is in the range of 0.5 and 3 s⁻¹.

19. The method according to any of the claims 1 to 18, further comprising the step of drying the high shear treated particulate material.

20. The method according to any of the claims 1 to 19, wherein the particulate material and liquid are exposed to high shear until at least 5% of the particles are destroyed or or broken down to a size outside the size distribution of the particulate starting material.

21. The method according to any of the claims 1 to 20, wherein the shape factor, ξ, of the particulate starting material is less than 0.5 and greater than 0.5 after the high shear treatment.

22. The method according any of the claims 1 to 20, wherein the shape factor of the particulate starting material is improved by at least 0.1.

23. A particulate composition obtainable from the method of claims 1-22

24. The composition of claim 23, wherein 95 wt % of the particles are capable of withstanding 20 kPa in an AJAX standard attrition shear cell.

25. The composition of claim 24, wherein the particles are enzyme granules

26. The composition of claim 24, wherein the shape factor, ξ, of the particles is greater than 0.5
